(19) United States
(12) Patent Application Publication
(10) Pub. No.: US 2004/0176073 A1
(43) Pub. Date: Sep. 9, 2004

(54) Notification of a cellular user's connection to the cellular network

(76) Inventors: Louis Robert Litwin JR., Plainsboro, NJ (US); Purvin Bibhas Pandit, Somerset, NJ (US)

Correspondence Address: JOSEPH S. TRIPOLI, THOMSON MULTIMEDIA LICENSING INC., 2 INDEPENDENCE WAY, P. O. BOX 5312, PRINCETON, NJ, 08543-5312, US

(21) Appl. No.: 10/383,453

(22) Filed: Mar. 6, 2003

(51) Int. Cl. H04Q 7/20

(52) U.S. Cl. 455/412.2; 455/433

(57) ABSTRACT

A method by a cellular network for notifying a caller when a called user is connected to the cellular network includes the steps of storing a phone number associated with a caller that wants to be notified when a called user is connected to the cellular network, registering the called user with the cellular network when a communication device associated with the called user becomes active on the network, and notifying the caller indicating that the communication device is active on the network responsive to the step of registering by the called user.

### BACKGROUND

1. Technical Field

This disclosure relates to wireless communications and, more particularly to notifying callers that a called number previously not connected to a cellular network is now connected to the cellular network and can be contacted.

2. Description of the Related Art

When a caller calls another person's phone, the cellular network will know if the other person's phone is registered with the network and thus, connected to the network. If the other person's phone is connected to the network the local Mobile Switching Center will access the Home Location Register (HLR) database to determine that the other person's phone is active and process the call. The other person's phone will receive a notification transmission that the caller is attempting to call.

When the other person is not connected to the cellular network the caller's mobile switching center will be unable to process the call. With current cellular technology the only option is for a caller to continually call the other person until that person's phone is active and registered as connected to the network.

Accordingly, a need exists for a method of informing the caller when the other party's phone is active again.

### SUMMARY OF THE INVENTION

A method for caller notification when a called device is registered with a cellular network includes the steps of storing information identifying a caller in a database of a cellular network associated with a called user, and notifying the caller when the called user registers with the cellular network having the phone number of the caller.

A method by a cellular network for notifying a caller when a called user is connected to the cellular network includes the steps of storing a phone number associated with a caller that wants to be notified when a called user is connected to the cellular network, registering the called user with the cellular network when a communication device associated with the called user becomes active on the network, and notifying the caller indicating that the communication device is active on the network responsive to the step of registering by the called user.

A computer readable medium containing software instructions that, when executed by a processor, performs the steps of storing a caller's phone number in a database associated with a called user in reply to the caller indicating that notification should be given when the called user becomes active on a cellular network after the caller called the called user, and notifying the caller when the called user is active on the cellular network within time limit set by the caller.

A wireless communications device is configured for performing the steps of transmitting to a wireless network a call for a recipient, receiving from the wireless network that the recipient is not connected to the wireless network, instructing the wireless network that a notification be given indicating the recipient is connected to the network, and receiving a notification that the recipient is connected to the network.

These and other objects, features and advantages of the present invention will become apparent from the following detailed description of illustrative embodiments thereof, which is to be read in connection with the accompanying drawings.

### BRIEF DESCRIPTION OF DRAWINGS

This disclosure will present in detail the following description of preferred embodiments with reference to the following figures wherein:

FIG. 1 is a diagram of the home location register HLR processing in accordance with the present invention;

FIG. 2 is a diagram of cellular network elements involved in the home location register HLR processing in accordance with the present invention; and

FIG. 3 is a diagram of additional fields to the home location register HLR database in accordance with the present invention.

### DETAILED DESCRIPTION OF PREFERRED EMBODIMENTS

The inventive method is for a cellular network to inform a caller when a person that was recently called and whose phone was not on or was out of service has become active on the cellular network. The invention requires a modification to the existing cellular system. In particular, additional fields can be added to the Home Location Register (HLR) database to facilitate additional processing.

When the calling user calls the called user's phone, the cellular network will know whether or not the called user's phone is registered with the network and thus active. If the phone is not registered with the network, either because it is turned off or not in a service area, the network will give the calling user the option of being notified when the called user's phone is active again. The network can prompt the calling user for a time limit for this notification. For example, the network can notify the calling user if the called user's phone is turned on within the next hour, or perhaps within the next 5 hours. The caller preferably chooses the time limit when a notification should be sent to the calling user.

The next time that the called user registers with the network, the network will check to see if there are any callers who need to be notified. If these callers' time limits have not expired, the network can send a text message or some other notification to the calling user(s) to inform them that their previously unavailable called user is now active in the network.

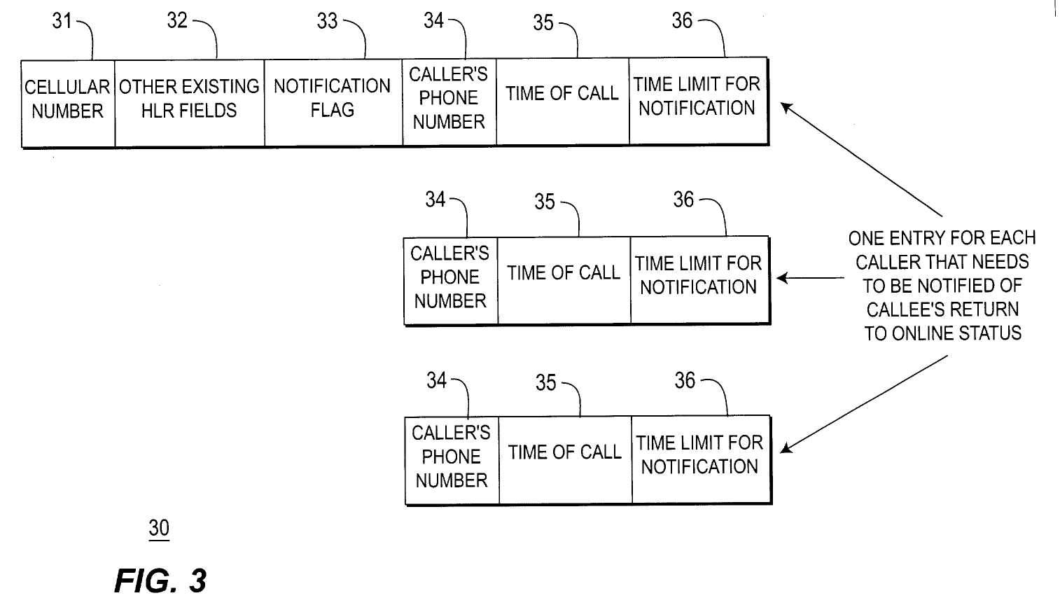

Referring to FIG. 3 there is shown a diagram 30 of a home location register HLR database modified in accordance with the present invention. The called user's cellular number 31 and other existing HLR fields 32 are supplemented with additional fields. The additional fields need to be added to the HLR database for each caller. A notification flag 33 indicates whether or not the user is subscribed to the notification service. A phone number of the caller 34, time the caller called 35 and a time limit for notifying that the called user is active on the cell network 36 are added.

Additional processing needs to be performed with these fields by the home service provider also referred to as a Mobile Switching Center (MSC).

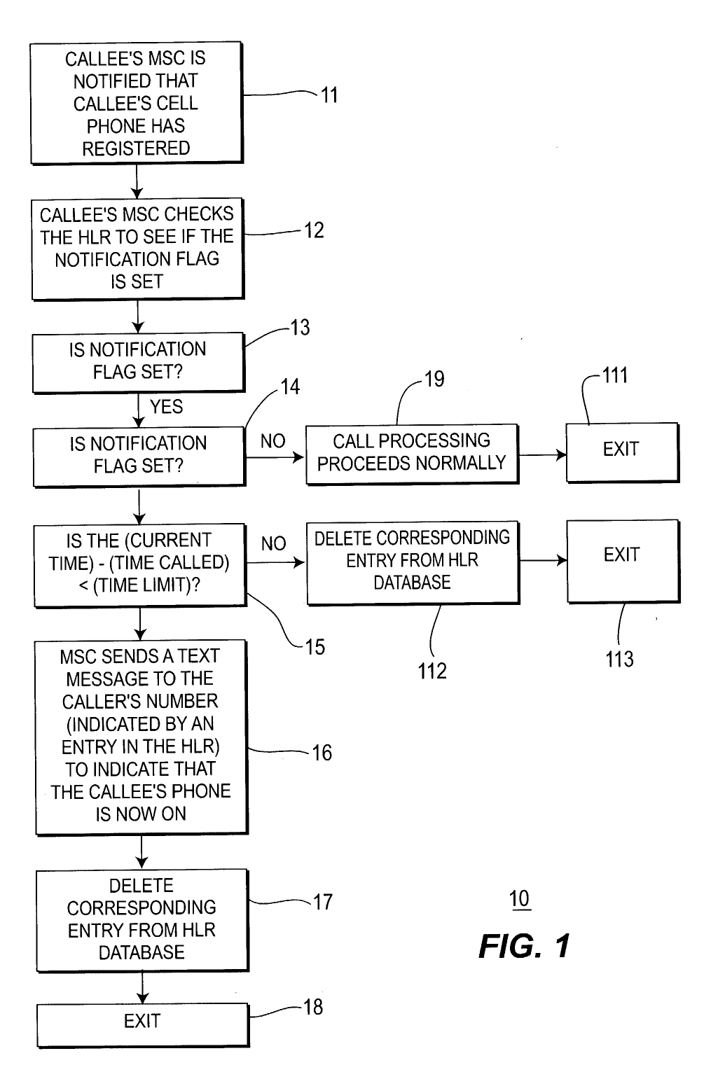

Referring to FIG. 1, the block diagram 10 shows the HLR processing for notifying that a previously called user is registered with the cellular network as online and the called user's phone is active and connected to the cellular network. A caller places a cellular call to the called user's cell phone that is currently off or out of service, resulting in the called user not being registered on the cell network. As typically occurs in such a situation, the network's Mobile Switching Center MSC for the called user processes this call. When this occurs, the Mobile Switching Center MSC checks the Notification Flag field 12, 13 in the caller's HLR database 30.

If the Notification Flag is set, the Mobile Switching Center MSC records the phone number of the caller 34, the time that the caller called 35, and the caller-specified time limit for notification 36,15. If the Notification Flag is not set the call processing proceeds normally 19 and the HLR processing ends 111. When the current time minus the time called is not less than the caller-specified time limit 15 the corresponding field entries 34,35,36 including the Notification Flag 33 in the HLR database are deleted and the processing ends 113.

When the called user turns on his cell phone and registers, the called user's Mobile Switching Center MSC is notified. Even if the called user is roaming, the local Mobile Switching Center MSC's Visiting Location Register (VLR) must access the called user's HLR. When it does so, the called user's Mobile Switching Center MSC will know that the called user has turned his phone on.

The called user's Mobile Switching Center MSC compares the current time to the HLR entry that indicates when the caller called. If this time difference is within the caller-specified time limit for notification 15 (indicated by an entry in the HLR), the Mobile Switching Center MSC sends a text message 16 to the caller's phone number (indicated by an entry in the HLR) to indicate that the called user's phone is now registered, meaning the called user's phone is connected to the cellular network. The Mobile Switching Center MSC deletes the corresponding entry from the HLR database 17 and ends the HLR processing for this call notification.

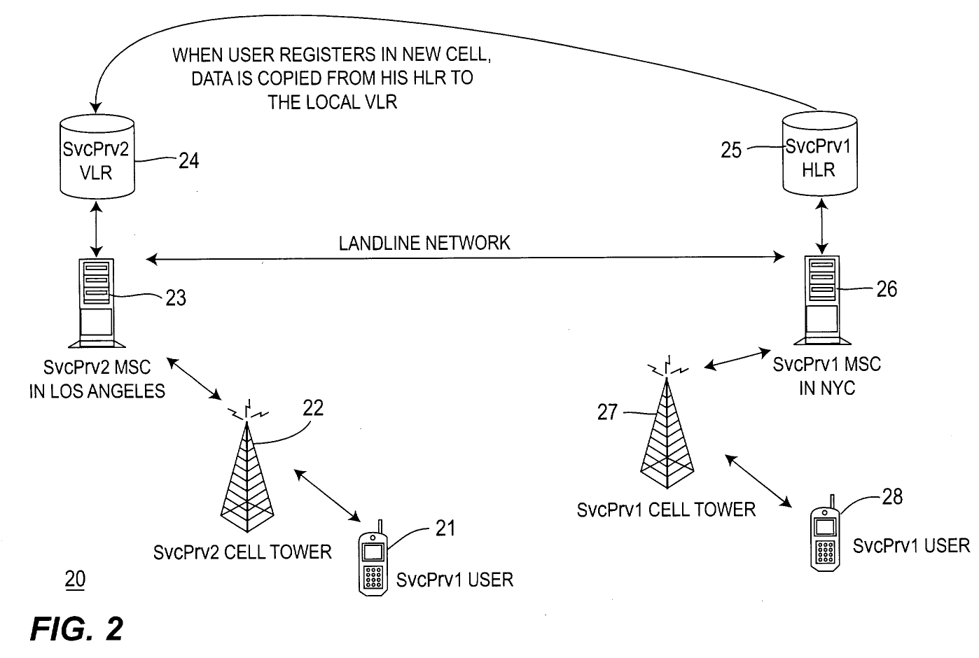

The cellular network elements involved in the inventive HLR processing are shown 20 in FIG. 2. A caller or user 28 connects over a first service provider's SvcPrv1 cell tower 27 with that first service provider's SvcPrv1 Mobile Switching Center MSC server 26. The Mobile Switching Center server 26 contains the first service provider's SvcPrv1 Home Location Register HLR database 25 for the caller 28. Often that same caller will register over a cell tower 22 in a new cell network 22,23,24 with a second service provider's SvcPrv2 Visiting Location Register VLR 24 database on the second service provider's SvcPrv2 Mobile Switching Center MSC 23. In such cases when the caller 21, 28 registers in the new cell 21,22,23,24, data for the caller notification processing is copied from the caller's home location register HLR 25 with the first service provider SvcPrv1 server 26 to the new local Visitor's Location Register 24.

Having described a preferred method for caller notification of a return to active status of a called user (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims.

What is claimed is:

1. A method for caller notification when a called device is registered with a cellular network, said method comprising the steps of:
storing information identifying a caller in a database of a cellular network associated with a called user; and
notifying said caller when said called user registers with said cellular network having said phone number of said caller.

2. The method according to claim 1, wherein said step of storing further comprises storing a time of a call by said caller and a time limit for notifying when said called user registers with said cellular network.

3. The method according to claim 1, wherein said database comprises a Home Location Register for said called user.

4. The method according to claim 1, wherein said information identifying said caller is a phone number associated with said caller.

5. The method according to claim 1, wherein said database comprises a home location register for said called user, said home location register being modified to include a phone number associated with said caller.

6. The method according to claim 5, wherein said home location register is modified to store a time of call to said called user by said caller, and a time limit for notifying said caller when said called user is registered with said cellular network.

7. The method according to claim 1, wherein said step of storing includes storing a time limit for notifying said caller when said called user is registered with said network.

8. The method according to claim 7, wherein said time limit for notifying is set by said caller.

9. The method according to claim 1, wherein said step of notifying comprises one of sending a text message, sending an e-mail and making a phone call to said caller informing that a device associated with said called user is active.

10. The method according to claim 1, wherein said storing comprises storing in said database a notification flag, a caller's number, time that said caller called, and a time limit for said step of notifying.

11. A method by a cellular network for notifying a caller when a called user is connected to the cellular network, said method comprising the steps of:
storing a phone number associated with a caller that wants to be notified when a called user is connected to the cellular network;
registering said called user with said cellular network when a communication device associated with said called user becomes active on said network; and
notifying said caller indicating that said communication device is active on said network responsive to said step of registering by said called user.

12. The method by said cellular network according to claim 11, wherein said storing comprises modifying a home location register for said called user with a phone number of said caller.

13. The method according to claim 12, wherein said storing comprises one of 1) modifying said home location register with setting a notification flag, storing a time of call by said caller and a time limit for said notifying and 2) modifying said home location register with setting a notification flag, storing a time of last call to said called user by said caller out of multiple calls to said called user and a time limit for said notifying.

14. The method according to claim 11, further comprising a step before said step of storing of notifying a caller that said called user is unregistered with said cellular network and giving said caller an option of being notified when said caller user has become active on said cellular network.

15. A computer readable medium containing software instructions that, when executed by a processor, performs the steps of:
storing a caller's phone number in a database associated with a called user in reply to said caller indicating that notification should be given when said called user becomes active on a cellular network after said caller called said called user; and
notifying said caller when said called user is active on said cellular network within time limit set by said caller.

16. The computer readable medium according to claim 15, wherein said step of notifying comprises one of sending said caller a text message and sending said caller a phone number for said called user when said called user is active on said cellular network.

17. The computer readable medium according to claim 15, further comprising storing a time limit for carrying out said step of notifying, said time limit being one of predetermined and set by said caller.

18. A wireless communications device configured for performing the steps of:
transmitting to a wireless network a call for a recipient;
receiving from said wireless network that said recipient is not connected to said wireless network;
instructing said wireless network that a notification be given indicating said recipient is connected to said network; and
receiving a notification that said recipient is connected to said network.

19. The wireless communications device according to claim 18, wherein said wireless network is a cellular network.

20. The wireless communications device according to claim 18, wherein said step of receiving a notification comprises receiving a text message indicating that said recipient is connected to said network.
